(19) United States
(12) Patent Application Publication
(10) Pub. No.: US 2016/0328674 A1
(43) Pub. Date: Nov. 10, 2016

(54) METHOD AND SYSTEM FOR OMNI-CHANNEL MULTI-HUB ORDER AND INVENTORY MANAGEMENT

(71) Applicant: Infosys Limited, Bangalore (IN)

(72) Inventors: Dharmendra Tripathi, Bangalore (IN); Sachin Girijashankar Agrawal, Bangalore (IN)

(21) Appl. No.: 15/142,287

(22) Filed: Apr. 29, 2016

(30) Foreign Application Priority Data
May 5, 2015 (IN) 2277/CHE/2015

(51) Int. Cl. G06Q 10/08; G06Q 30/06

(52) U.S. Cl. CPC G06Q 10/087; G06Q 30/0635

(57) ABSTRACT

A method a system, and/or apparatus for omni-channel multi-hub order and inventory management system. The method involves receiving a request through an order capture channel an inventory stock. An availability of the inventory stock is checked in a computer database associated with a primary hub. When the inventory stock is available in the primary database, the received request is fulfilled. When the inventory stock is not available, the availability is checked in a stock cache associated with the one or more secondary hubs. One of the one or more secondary hubs is chosen based on one or more proximity to a delivery location and a priority. The received request is sent to the identified secondary hub to fulfill the received request. The request may be backordered at the primary hub when the inventory stock is not available at the stock cache associated with the one or more secondary hubs.

This application claims priority to India Patent Application No. 2277/CHE/2015, filed May 5, 2015, the disclosure of which is hereby incorporated by reference in its entirety.

### FIELD OF TECHNOLOGY

The present disclosure generally relates to supply chain commerce and in particular, to a system, method and/or apparatus for omni-channel multi-hub order and inventory management.

### BACKGROUND

Supply Chain Management (SCM) may be defined as a management of flow of goods and services from a manufacturer and/or a service provider to a consumer. SCM may include movement and storage of raw materials, work-in-process inventory, and finished goods from point of origin to point of consumption or destination. Interconnected or interlinked networks, channels and node businesses may be involved in provision of products and services required by the consumers in a supply chain.

In order to have a seamless experience in the Supply Chain Management, availability of inventory stock plays an important role. Inventory management may be defined as a process of planning a procurement to ensure the availability of item(s) when needed, by keeping track of existing inventory across networks and selling it to the consumer. Two common inventory-management strategies may be, a just-in-time strategy and an inventory management by strategic planning. In the just-in-time strategy, companies may plan to receive items as they are needed rather than maintaining high inventory levels. In the inventory management by strategic planning, material procurement may be scheduled and the inventory levels may be maintained based on sales forecast and historical data to keep optimum inventory available

There has been a dramatic upsurge of inventory transaction and data volume due to emergence of new capabilities like an omni channel, a cross channel and a global inventory visibilities in a retail and a manufacturing space. In addition to the said capabilities, load on inventory system has gone up by 50 to 200 times.

Enterprises have tried solving problem by creating a visibility solution using Not Only SQL (NoSQL) database (Casandra and Mongo DB) technology to address the load and scale of the order and inventory transaction. Addressing inventory transactions has been always a challenge due to inherent limitations in a NoSQL data solution.

### SUMMARY

Disclosed are a method, system and/or apparatus for omni-channel multi-hub order and inventory management.

In one aspect, a computer implemented method for omni-channel multi-hub inventory management system is disclosed. The method involves receiving at an order capture channel of the order and inventory management system, a request for an inventory stock from a computing system. The request may be for identification of inventory stock in one or more secondary hubs. The request may also be for allocation of the inventory stock from one or more fulfillment nodes. The one or more fulfillment nodes is associated with one or more secondary hubs. An availability of the inventory stock is checked in a computer database associated with a primary hub.

When the inventory stock is available in the primary hub, the received request is fulfilled. When the inventory stock is not available in the primary hub, the availability is checked in a stock cache associated with the one or more secondary hubs. One of the one or more secondary hubs is chosen based on one of a proximity to a delivery location and a priority. The stock cache associated with the one or more secondary hubs consists a stock summary of one or more fulfillment nodes. The stock summary may be a collective information of the inventory stock at each of the one or more fulfillment nodes associated with each of the plurality of secondary hubs. The received request may be sent to the chosen (identified) secondary hub to fulfill the received request. The one or more fulfillment nodes may be one or more of, a distribution center, a store, a drop ship vendor, a supplier and a manufacturer.

The request may be backordered at the primary hub when the inventory stock is not available at the stock cache of one or more secondary hubs. The secondary hubs may be communicatively coupled asynchronously with the primary hub.

In another aspect, a system for omni-channel multi-hub inventory management is disclosed. The system comprises a receiver, a checker, a primary hub, a stock cache, one or more secondary hubs, a sender, and one or more fulfillment nodes.

The receiver is configured to receive at an order capture channel of the inventory management system, a request for an inventory stock from a computing system. The request may be for identification of inventory stock in one or more secondary hubs. The request may also be for allocation of the inventory stock from one or more fulfillment nodes. The one or more fulfillment nodes is associated with one or more secondary hubs. The checker is configured to check an availability of the inventory stock in a computer database associated with a primary hub.

When the inventory stock is available in the primary hub, the received request is fulfilled by the primary hub. When the inventory stock is not available in the primary hub, the primary hub checks the availability in a stock cache associated with the one or more secondary hubs. The stock summary may be a collective information of the inventory stock at each of the one or more fulfillment nodes associated with each of the plurality of secondary hubs. One of the one or more secondary hubs is chosen based on one of a proximity to a delivery location and a priority. The stock cache associated with the one or more secondary hubs consists a stock summary of one or more fulfillment nodes. The received request may be sent to the chosen (identified) secondary hub to fulfill the received request. The one or more fulfillment nodes may be one or more of, a distribution center, a store, a drop ship vendor, a supplier and a manufacturer.

The request may be backordered at the primary hub when the inventory stock is not available at the stock cache of one or more secondary hubs. The secondary hubs may be communicatively coupled asynchronously with the primary hub.

In an additional aspect, a non-transitory computer readable storage medium for omni-channel multi-hub order and inventory management system is disclosed. The computer readable storage medium stores computer executable instructions to receive at an order capture channel of the inventory management system, a request for receiving at an order capture channel of the inventory management system, a request for an inventory stock from a computing system. The request may be for identification of inventory stock in one or more secondary hubs. The request may also be for allocation of the inventory stock from one or more fulfillment nodes. The one or more fulfillment nodes is associated with one or more secondary hubs. An availability of the inventory stock is checked in a computer database associated with a primary hub.

When the inventory stock is available in the primary hub, the received request is fulfilled. When the inventory stock is not available in the primary hub, the availability is checked in a stock cache associated with the one or more secondary hubs. One of the one or more secondary hubs is chosen based on one or more proximity to a delivery location and a priority. The stock cache associated with the one or more secondary hubs consists a stock summary of one or more fulfillment nodes. The stock summary may be a collective information of the inventory stock at each of the one or more fulfillment nodes associated with each of the plurality of secondary hubs. The received request may be sent to the chosen (identified) secondary hub to fulfill the received request. The one or more fulfillment nodes may be one or more of, a distribution center, a store, a drop ship vendor, a supplier and a manufacturer.

The request may be backordered at the primary hub when the inventory stock is not available at the stock cache of one or more secondary hubs. The secondary hubs may be communicatively coupled asynchronously with the primary hub.

The methods, the systems and/or the apparatus disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE FIGURES

Example embodiments are illustrated by way of example and not limitation in the figures of the accompanying drawings, in which like references indicate similar elements and in which:

FIG. 1 is a diagrammatic representation of a data processing system capable of processing a set of instructions to perform any one or more of the methodologies herein, according to one embodiment.

FIG. 2 is a diagram, illustrating a system for omni-channel multi-hub order and inventory management, according to one or more embodiments.

FIG. 3 is a process flow diagram, illustrating a method for omni-channel multi-hub order and inventory management, according to one or more embodiments.

FIG. 4 is a block diagram, illustrating a system for omni-channel multi-hub order and inventory management, according to one or more embodiments.

FIG. 5 is a process flow diagram, illustrating identification (sourcing) of inventory stock in a primary hub and a secondary hub, according to one or more embodiments.

FIG. 6 is a process flow diagram, illustrating reservation of inventory stock in a primary hub and a secondary hub, according to one or more embodiments.

FIG. 7 is a block diagram, illustrating events of primary hub and secondary hub during inventory stock identification and allocation, according to one or more embodiments.

Other features of the present embodiments will be apparent from the accompanying drawings and from the detailed description that follows.

### DETAILED DESCRIPTION

Example embodiments, as described below, may be used to provide a method, a system and/or apparatus for omni-channel multi-hub order and inventory management system. Although the present embodiments have been described with reference to specific example embodiments, it will be evident that various modifications and changes may be made to these embodiments without departing from the broader spirit and scope of the various embodiments.

Omni-channel multi-hub order and inventory management system may scale an inventory management system horizontally in addition to vertical scaling through hub capabilities. The Omni-channel multi-hub order and inventory management system may eliminate dependency on single order and single inventory management hub.

The Omni-channel multi-hub order and inventory management system may decouple primary hub and secondary hub model. The primary hub may hold one or more order processing tasks with one percent or lesser of inventory transactions for one or more critical fulfillment nodes. The secondary hub may manage ninety-nine percent or greater of the one or more inventory transactions. An asynchronous communication between the primary hub and the secondary hub may address visibility of network inventory through a secondary hub inventory cache associated with the primary hub. One or more fulfillment nodes may be communicatively coupled asynchronously with the secondary hub.

In one or more embodiments, a critical fulfillment node may be one or more nodes, handling/fulfilling majority of demand of an inventory from a consumer. In another embodiment, a critical fulfillment node may be one or more nodes, frequently searched for availability of an inventory. Ninety-nine percent or greater of inventory transactions may be processed by one or more secondary hubs.

Due to decoupled interaction between the primary hub and the secondary hub, omni-channel multi-hub order and inventory management system may provide high degree of flexibility for an addition and a removal of one or more secondary hubs. In one or more embodiments, an omni-channel multi-hub order and inventory management system may have an ability to seamlessly move a fulfillment node from one hub to another hub. Capability and performance of the secondary hub may remain unaltered on the addition and the removal of the one or more secondary hubs and/or fulfillment nodes.

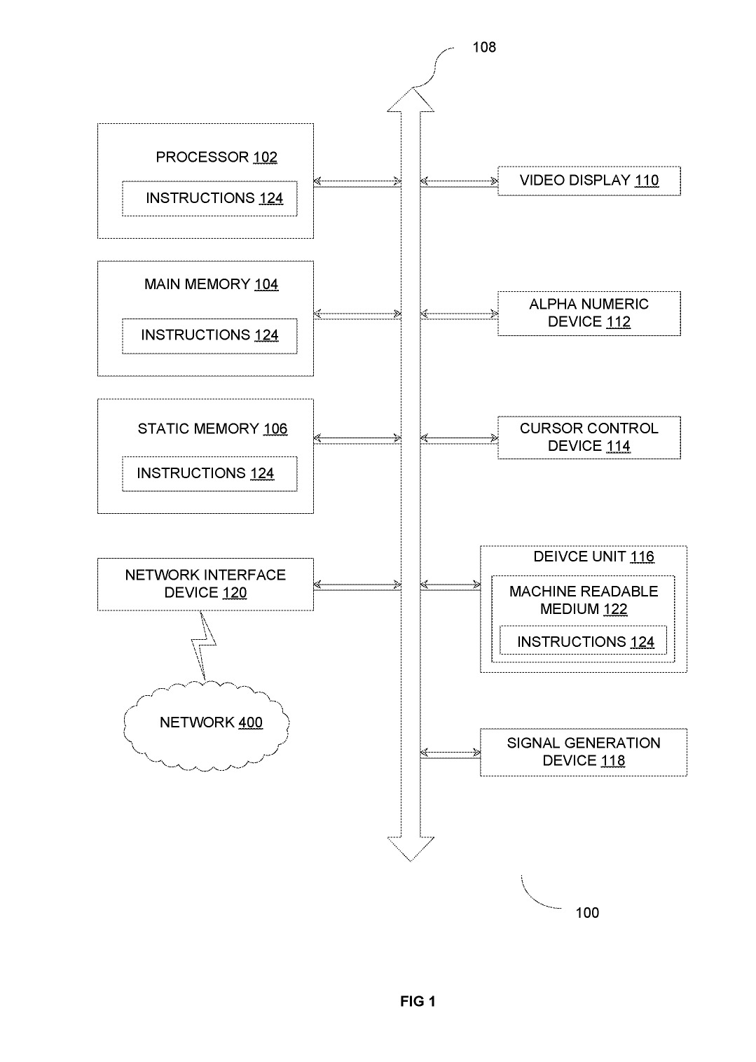

FIG. 1 is a diagrammatic representation of a data processing system capable of processing a set of instructions to perform any one or more of the methodologies herein, according to one embodiment. FIG. 1 shows a diagrammatic representation of machine in the example form of a computer system 100 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and/or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 100 includes a processor 102 (e.g., a central processing unit (CPU) a graphics processing unit (GPU) and/or both), a main memory 104 and a static memory 106, which communicate with each other via a bus 108. The computer system 100 may further include a video display unit 110 (e.g., a liquid crystal displays (LCD) and/or a cathode ray tube (CRT)). The computer system 100 also includes an alphanumeric input device 112 (e.g., a keyboard), a cursor control device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions 124 (e.g., software) embodying any one or more of the methodologies and/or functions described herein. The instructions 124 may also reside, completely and/or at least partially, within the main memory 104 and/or within the processor 102 during execution thereof by the computer system 100, the main memory 104 and the processor 102 also constituting machine-readable media.

The instructions 124 may further be transmitted and/or received over a network 400 via the network interface device 120. While the machine-readable medium 122 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Exemplary embodiments of the present disclosure provide a system, method and/or apparatus for omni-channel multi-hub order and inventory management system. The method involves receiving at an order capture channel of the inventory management system, a request for an inventory stock from a computing system. The request may be for identification of inventory stock in one or more secondary hubs. The request may also be for allocation of the inventory stock from one or more fulfillment nodes. The one or more fulfillment nodes may associated with one or more secondary hubs. An availability of the inventory stock is checked in a computer database associated with a primary hub.

When the inventory stock is available in the primary database, the received request may be fulfilled. When the inventory stock is not available in the primary hub, the availability may be checked in a stock cache associated with the one or more secondary hubs. One of the one or more secondary hubs may be chosen based on one of a proximity to a delivery location and a priority. The stock cache associated with the one or more secondary hubs may consist stock summary of one or more fulfillment nodes. The stock summary may be a collective information of the inventory stock at each of the one or more fulfillment nodes associated with each of the plurality of secondary hubs. The received request may be sent to the chosen (identified) secondary hub to fulfill the received request. The one or more fulfillment nodes may be one or more of, a distribution center, a store, a drop ship vendor, a supplier and a manufacturer. In one or more embodiments, a stock summary may be an inventory summary.

In one or more embodiments, when the inventory stock is not available in the primary database, the received request or the inventory stock may be checked against one or more secondary hubs for availability.

The request may be backordered at the primary hub when the inventory stock is not available at the stock cache of one or more secondary hubs. The secondary hubs may be communicatively coupled asynchronously with the primary hub. The stock cache may comprise information of inventory availability summary of each of one or more secondary hubs.

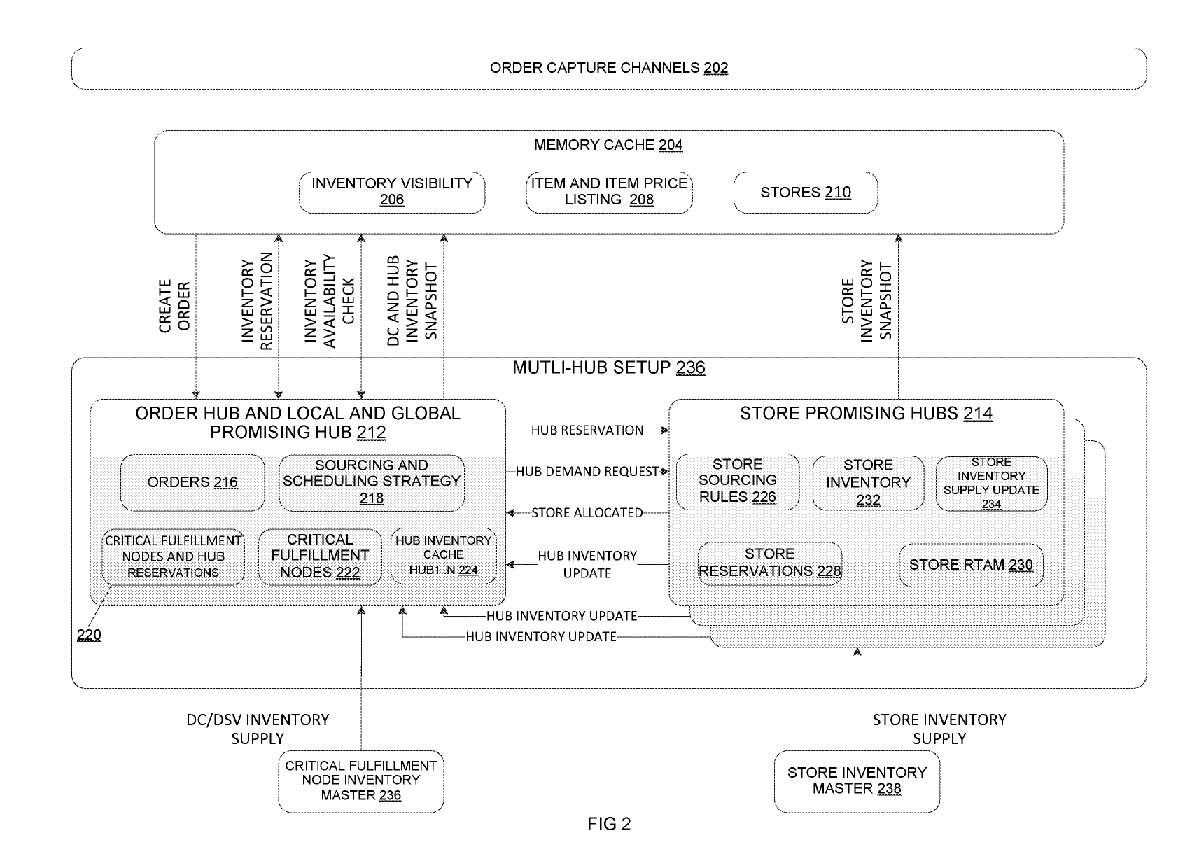

FIG. 2 is a diagram, illustrating a system for omni-channel multi-hub order and inventory management, according to one or more embodiments. An order capture channel 202 may be configured to receive a request from a customer. The request may be for, but not limited a sourcing, an allocation and a reservation of an inventory. The order capture channel 202 may be a medium of capturing customer demand from one or more entry points. The one or more entry points may be, but not limited to e-commerce site, mobile, kiosk, store point of sale, market place, social networking site, and Electronic Data Interchange (EDI) channel.

In one or more embodiments, a memory cache 204 may comprise an inventory visibility 206, an item and price listing 208 and stores 210. The inventory visibility 206 may comprise information related to availability of inventory in one or more locations. The item and item price listing 208 may comprise data related to one or more inventories.

In one or more embodiments, the multi-hub setup 236 may comprise an order hub and local and global promising hub 212 and a store promising hub 214. In one or more embodiments, the multi-hub setup 236 may be an order and inventory management system. The order hub and local and global promising hub 212 may be a primary hub. The primary hub may comprise one or more orders 216, a sourcing and scheduling strategy 218, a critical fulfillment node and hub reservations 220, one or more critical fulfillment nodes 222 and a hub inventory cache (1 to N) 224.

In one or more embodiments, the one or more critical fulfillment nodes 222 may be, but not limited to one or more of a distribution center, a key store and a drop ship vendor. The sourcing and scheduling strategy 218 may be configured to store local and global sourcing and scheduling rules to ensure selection of appropriate fulfillment node.

A store promising hubs 214 may be communicatively coupled with the primary hub. The store promising hubs 214 may comprise a store sourcing rules 226, a store reservations 228, a store Real Time Availability Monitor (RTAM) 230, a store inventory 232, and a store inventory supply update 234.

In one or more embodiments, the store sourcing rules 226 may be configured to store one or more rules to identify a fulfillment node. The fulfillment node may be identified based on, but not limited to one or more of, a priority, a proximity, a fulfillment cost, an expected delivery date, a capacity of the fulfillment node and a number of shipments. The store RTAM 230 may be configured to provide information of inventory availability to a primary hub. Each of the store promising hubs 214 may be associated with the store RTAM 230 to send inventory information to a cache associated with the primary hub.

In one or more embodiments, the primary hub may send a hub reservation request and a hub demand request to the store promising hubs 214. Each of the store promising hubs 214 may send a hub inventory update to the primary hub.

In one or more embodiments, critical fulfillment node inventory master 236 and store inventory master 238 inventory master may be one or more of, but not limited to a Distribution Center (DC), a Drop Ship Vendor (DSV), a store, a manufacturer and a vendor. In one or more embodiments, critical fulfillment node inventory master 236 is communicatively coupled asynchronously with order hub and local and global promising 212. The critical fulfillment node inventory master 236 may handle one percent or lesser of inventory transaction load.

In one or more embodiment, the store inventory master 238 may be communicatively coupled asynchronously with store promising hub 214. The store inventory master 238 may handle ninety-nine percent or greater of inventory transaction load. Communications such as inventory reservation and an inventory availability check may be present between an order hub and local and global promising hub 212 and a memory cache 204. The memory cache 204 may send create order request to the order hub and local and global promising hub 212. The order hub and local and global promising hub 212 may send a DC and hub inventory snapshot to the memory cache 204. The store promising hubs 214 may send store inventory snapshot the memory cache 204.

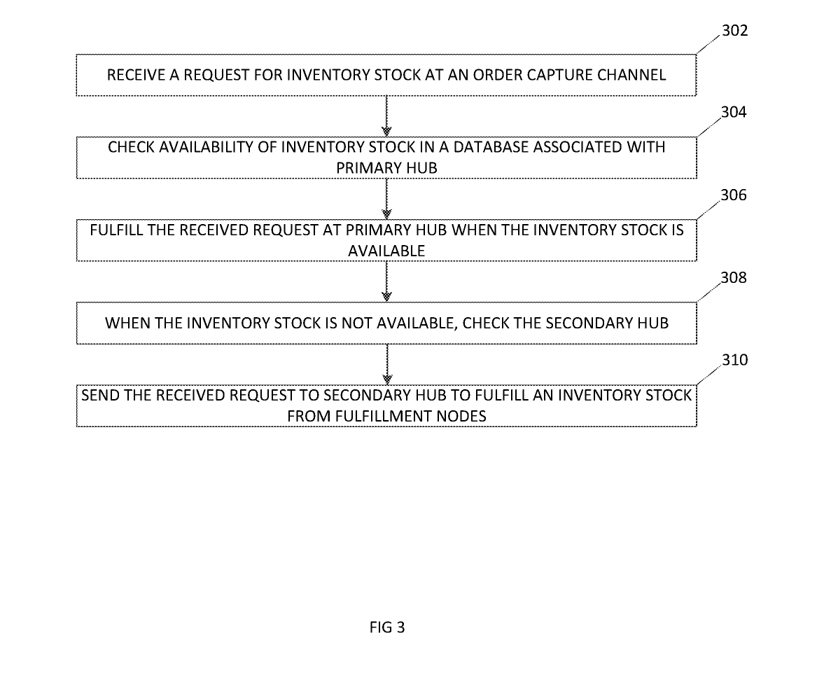

FIG. 3 is a process flow diagram, illustrating a method for omni-channel multi-hub order and inventory management, according to one or more embodiments. The method for omni-channel multi-hub order and inventory management system may involve receiving at an order channel of the inventory management system, a request for an inventory stock from a computing system, as in step 302. The order channel may be associated with an order processor. The computing system may be one or more of, but not limited to a computer, a mobile phone, and a hand held device, capable of sending a request to a computer network. The request may be for identification of availability (may also be referred as sourcing) of the inventory stock. In one or more embodiments, a request may be for a sourcing, an allocation and/or a reservation of an inventory stock.

A primary hub may be communicatively coupled asynchronously with one or more secondary hubs. One or more fulfillment nodes may be communicatively coupled asynchronously with the one or more of secondary hubs. The one or more fulfillment nodes may be, but not limited to a distribution center, a store, a drop ship vendor, a supplier and a manufacturer.

Availability of the inventory stock may be checked in a computer database associated with the primary hub, as in step 304. The primary hub may be one of, but not limited to distribution center and a drop ship vendor. When the inventory stock is available at the primary hub, the received request may be fulfilled, as in step 306. Fulfilling the request may be sending availability information of the inventory stock as a response to the received request, from the primary hub and/or the one or more secondary hubs. In one or more embodiments, fulfilling a request may be sending an allocation and/or reservation information of an inventory as a response to a request, from a primary hub and/or a secondary hub(s).

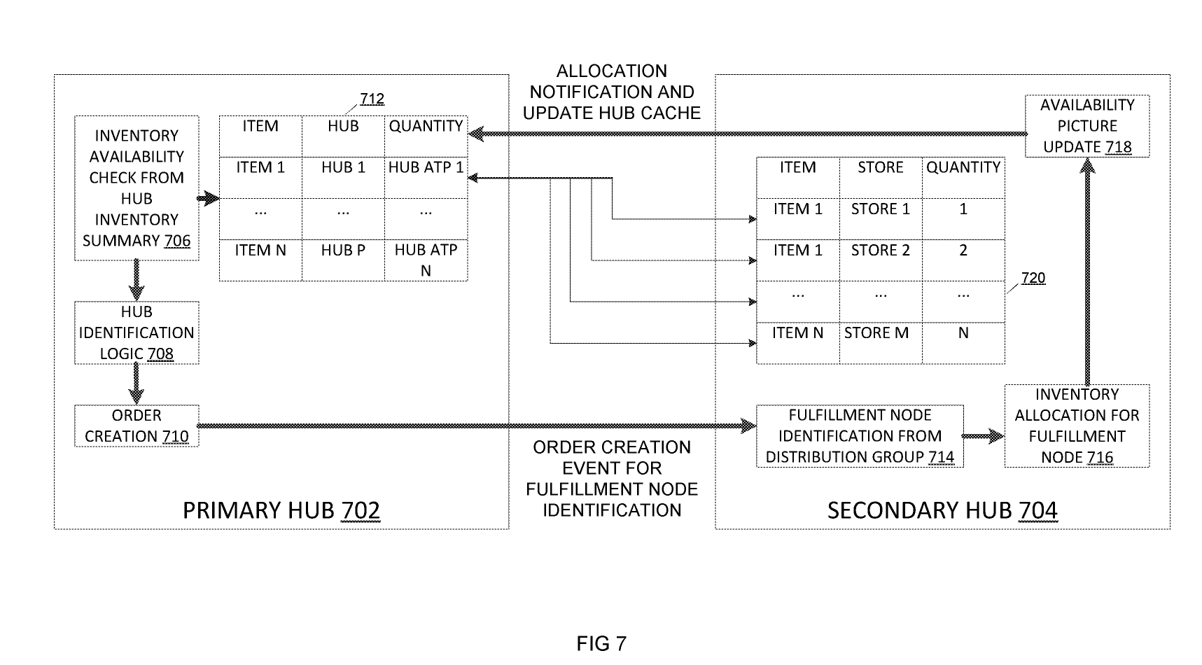

In one or more embodiments, an inventory stock may be available at a secondary hub. The availability of the inventory stock may be checked at a stock cache associated with the secondary hubs, as in step 308. The stock cache associated with the secondary hubs may consist a stock summary of the one or more fulfillment nodes associated with the secondary hub. The stock summary is illustrated in FIG. 7. In one or more embodiments, a stock cache may be associated with a primary hub. The stock cache may receive updated information from one or more secondary hubs.

When the inventory stock is available at the secondary hub, a request may be sent asynchronously to the secondary hub, as in step 310. The request may be fulfilled by one or more fulfillment nodes associated with the secondary hub.

In one or more embodiments, multiple secondary hubs may be available, communicatively coupled asynchronously with a primary hub. If the multiple secondary hubs are available, a secondary hub may be chosen from the multiple secondary hubs based on one of, but not limited to a proximity to a delivery location and a priority.

In one or more embodiments, when an inventory stock is not available at a stock cache, a request may be back ordered. The stock cache may be checked regularly for an availability of the inventory stock. The request may be fulfilled when the inventory stock is available.

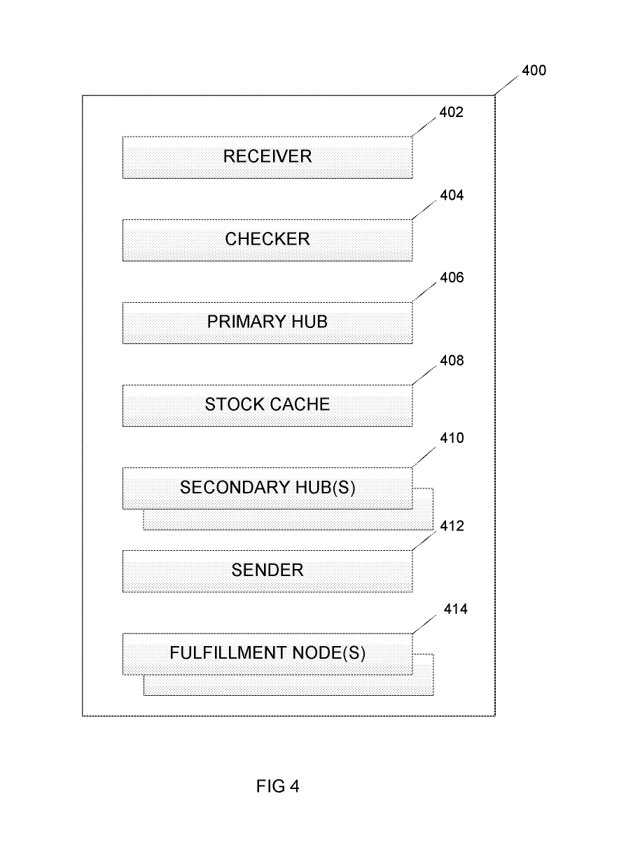

FIG. 4 is a block diagram, illustrating an omni-channel multi-hub order and inventory management system 400, according to one or more embodiments. The system 400 may include a receiver 402, a checker 404, a primary hub 406, a stock cache 408, one or more secondary hubs 410, a sender 412 and one or more fulfillment nodes 414. In one or more embodiments, the checker may be a cache, configured to check availability of an inventory. The receiver 402 may be configured to receive a request for an inventory stock from a computing system. The receiver 402 may be configured to receive the request through an order channel. The order channel may be associated with the receiver 402.

In one or more embodiments, the order channel may be associated with an order processor. The computing system may be one of, but not limited to a computer, a mobile phone, and a hand held device capable of sending a request to a computer network. The request may be for identification of availability of the inventory stock. In another embodiment, a request may be for an allocation and/or a reservation of an inventory stock.

The checker 404 may be configured to check availability of the inventory stock in a computer database associated with the primary hub 406. The primary hub 406 may be, but not limited to a distribution center, a critical store and a drop ship vendor. The primary hub 406 may be configured to fulfill the received request, when the inventory stock is available. Fulfilling the request may be sending availability information of the inventory stock as a response to the request, from the primary hub 406 and/or the one or more secondary hubs 410. In another embodiment, fulfilling a request may be sending an allocation information and/or a reservation information of an inventory as a response to a request, from a primary hub 406, one or more secondary hubs 410 and/or one or more fulfillment nodes 414.

In one or more embodiments, an inventory stock may be available at one or more secondary hubs 410. The one or more secondary hubs 410 are communicatively coupled asynchronously with a primary hub 406. The primary hub 406 may be further configured to check a stock cache 408, associated with the one or more secondary hubs 410. The stock cache 408 associated with the one or more secondary hubs 410 may consist a stock summary of the one or more fulfillment nodes 414 associated with the one or more secondary hub 410. The stock summary is illustrated in FIG. 7.

In one or more embodiment, a stock cache 408 may be associated with a primary hub 406. The primary hub 406 may receive regular update from one or more secondary hubs 414, to update details of an inventory in the stock cache 408.

When the inventory stock is available at the one or more secondary hubs 410, the sender 412 may be configured to send a request asynchronously to an identified secondary hub of one or more secondary hubs 410. The identified secondary hub may be one of one or more secondary hub 410, containing the inventory stock. The request may be fulfilled by of one or more fulfillment nodes 414 associated with the identified secondary hub.

In one or more embodiments, one or more fulfillment nodes 414 may be communicatively coupled asynchronously with one or more secondary hubs 410. The one or more fulfillment nodes 414 may be, but not limited to a distribution center, a store, a drop ship vendor, a supplier and a manufacturer.

In one or more embodiments, multiple secondary hubs may be available, communicatively coupled asynchronously with a primary hub. If the multiple secondary hubs are available, a secondary hub may be chosen from the multiple secondary hubs based on one of, but not limited to a proximity to a delivery location and a priority.

In one or more embodiments, on non-availability of inventory stock at a stock cache 408, a request may be backordered. The stock cache 408 may be checked regularly for the availability of the inventory stock. The request may be fulfilled when the inventory stock is available.

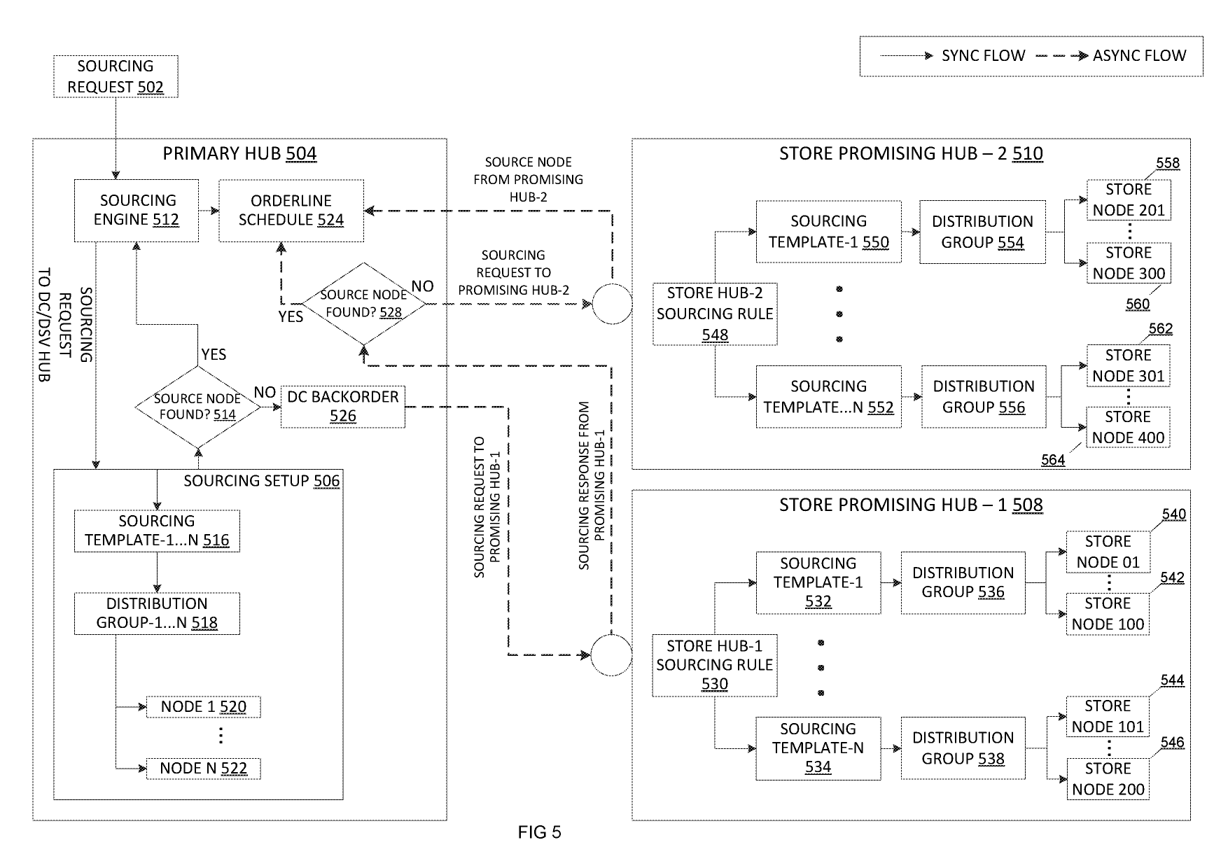

FIG. 5 is a process flow diagram, illustrating identification (sourcing) of inventory stock in a primary hub and a secondary hub, according to one or more embodiments. A sourcing (may also be referred as identification or allocation) request 502 may be sent to a sourcing engine 512, associated with the primary hub 504.

In one or more embodiments, a hub may be one or more instances of an order and inventory management system. The hub may own one or more configurations, rules and data related to the order and inventory management system. The data may be a master data and/or a transaction data of order and inventory management system. A primary hub may be an instance of the order and inventory management system. The primary hub may handle orders processed in the order and inventory management system. The primary hub may contain visibility of one or more secondary hubs. Sourcing may be a capacity of a solution to apply one or more identified constraints/parameters to select an appropriate fulfillment node.

In one or more embodiments, a fulfillment node may be defined as a node and the fulfillment node may own inventory and fulfill a demand promised to a customer (consumer). The node may be defined as physical entity and the node may own one or more item inventories. In one or more embodiments, the node may be, but not limited to a store, a manufacturer, and a distribution center, a warehouse and a drop-ship-vendor.

The sourcing engine 502 may check for availability of an inventory in the primary hub 504. The sourcing engine 502 may check the availability of the inventory based on one or more rules, but not limited to a priority, a proximity, a fulfillment cost, number of shipments, and an expected delivery date. The sourcing engine 502 may check the availability of the inventory in a sourcing setup 506, communicatively coupled with the sourcing engine 502. The sourcing setup 506 may be part of cache associated with the primary hub 504.

In one or more embodiments, the sourcing setup 502 may comprise a sourcing template 516, a distribution group 1-N 518, and a node-1 520 to a node-N 522. The node-1 520 to the node-N 522 is communicatively coupled with the distribution group 1-N 518. The distribution group 1-N is communicatively coupled with the sourcing template 1-N 516.

In one or more embodiments, a distribution group may provide a facility to create a set of nodes. The distribution group may be associated with one or more sourcing rules. For each of the one or more sourcing rules, a sequence of sourcing template may be defined. The sourcing template may perform sourcing of one or more items in an order.

If the inventory is available at the sourcing setup 506 of the primary hub 504, the inventory may be allocated in the primary hub 504. A response may be sent to the sourcing engine 512. In one or more embodiments, allocation of inventory may be a process of blocking inventory at a primary hub or a secondary hub based on inventory node. The allocation may be performed by applying one or more sourcing rules and scheduling rules to ensure selection of an appropriate node.

If the inventory is not available as per the check 514 performed in primary hub 504, the primary hub 504 through the sourcing engine 512 may identify a best possible secondary hub for allocation of the inventory. The identification of the best possible secondary hub may be based on one of a priority or a proximity from location of the customer.

In one or more embodiments, a secondary hub may be an instance of solution which serves inventory and one or more transactions related to inventory allocation from fulfillment nodes. The secondary hub may provide visibility of one or more nodes (fulfillment nodes). The secondary hub may also manage availability of the fulfillment nodes. In another embodiment, the secondary hub may publish real time availability picture of fulfillment nodes to order capture channels. In another embodiment, the secondary hub may publish a consolidated (global) real time availability picture of the fulfillment nodes within the secondary to a primary hub.

During the process of identifying the best possible secondary hub, the sourcing request 502 may be backordered, as in 526. In one or more embodiments, a store promising hub-1 508 and a store promising hub-2 510 may be referred as secondary hubs. The best possible secondary hub may be one of the one or more secondary hubs, communicatively coupled asynchronously with a primary hub.

The store promising hub-1 508 may comprise a store hub-1 sourcing rule 530 and sourcing template-1 532 to sourcing template-N 534. A store node-01 540 to a store node-100 542 may be connected to a distribution group 536. The distribution group 536 may be connected to the sourcing template-1 532. Similarly, a store node-101 544 to store node-200 546 may be connected to a distribution group 538. The distribution group 538 may be connected to the sourcing template N 534. The sourcing template-1 532 to sourcing template-N 534 may be communicatively coupled with the store hub-1 sourcing rule 530.

Similarly, the store promising hub-2 510 may comprise a store hub-2 sourcing rule 548 and sourcing template-1 550 to template-N 552. A store node-201 558 to a store node-300 560 may be connected to a distribution group 554. The distribution group 554 may be connected to the sourcing template-1 550. Similarly, a store node-301 562 to store node-400 564 may be connected to a distribution group 556. The distribution group 556 may be connected to the sourcing template N 552. The sourcing template-1 550 to sourcing template-N 552 may be communicatively coupled with the store hub-2 sourcing rule 548.

The sourcing engine 512 of the primary hub 504 may send the sourcing request 502 to an identified secondary hub asynchronously. In the present embodiment, the identified secondary hub may be the store promising hub-1 508. The identified secondary hub may check the availability of the inventory amongst one or more connected nodes (store nodes). The inventory may said to be available at the identified secondary hub, if the inventory is available in one or more connected nodes.

If the inventory is available in the identified secondary hub, the identified secondary hub may respond to the primary hub 504 with the availability information. Based on the response, the primary hub 504 may send allocation request to the identified secondary hub, with inventory availability information of an identified node. The identified secondary hub may allocate an inventory in the identified node. If the condition of source node found 528 is satisfied, a response may be sent to the orderline schedule 524, asynchronously.

In one or more embodiments, the orderline schedule 524 may be responsible to identify a right sourcing node for an ordered item.

In one or more embodiments, the identified secondary hub may allocate the inventory against one of one or more fulfillment nodes. The allocation of the inventory may be based on one or more of, but not limited to a priority, a proximity, a fulfillment cost, a number of shipments, an expected delivery date, and a capacity of the fulfillment node.

In one or more embodiments, if the inventory is not available in the store promising hub-1 508, the sourcing request may be sent to the store promising hub-2 510. The store promising hub 2 510 may be considered as the identified hub. In one or more embodiments, a next best possible secondary hub may be identified based on a priority or a proximity from customer's location.

The sourcing engine 512 may send the sourcing request to the store promising hub-2 510 asynchronously. The store promising hub-2 510 may check the availability of the inventory. If the inventory is available in the store promising hub-2 510, the inventory may be allocated in a fulfillment node. In one or more embodiment, the allocation of the inventory may be based one or more of a priority, a proximity, a fulfillment cost, a number of shipments, an expected delivery date and a fulfillment node capacity.

In one or more embodiment, identification of a best secondary hub may be continued till one of the conditions are met. The conditions may be, best secondary hub is found and threshold of an inventory check in an identified secondary hub is reached.

In one or more embodiments, a primary hub and/or secondary hub may reach failure to fetch state. In case of failure to fetch, a sourcing request may get backordered. The failure to fetch state may be a non-availability of inventory in a secondary hub. The primary hub may be configured to wait for a configurable time and may retry by sending a sourcing request 502 to one or more secondary hubs.

In one or more embodiment, if a sourcing request 502 is not responded by the secondary hub, or an inventory is not available in one or more secondary hubs, the sourcing request 502 may be cancelled.

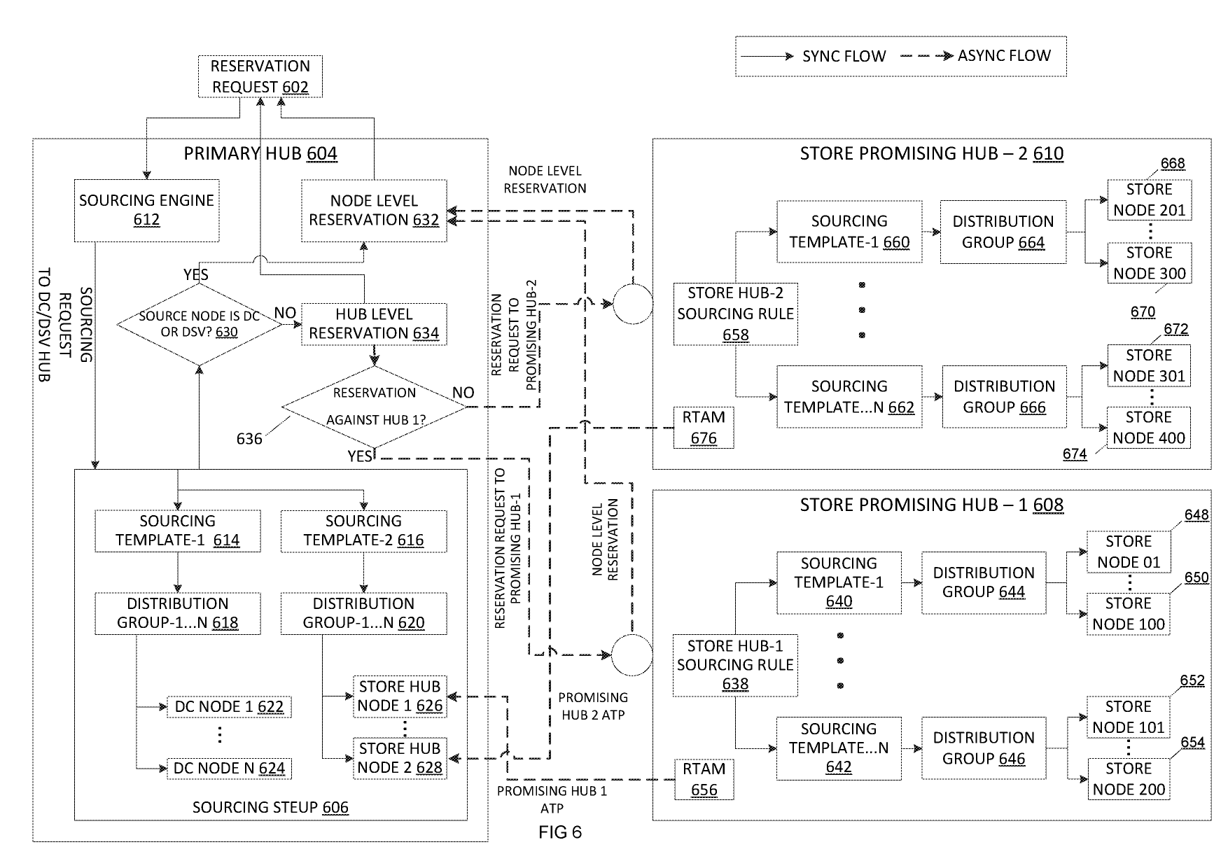

FIG. 6 is a process flow diagram, illustrating reservation of inventory stock in a primary hub and a secondary hub, according to one or more embodiments.

In one or more embodiments, a set of processes running in each of one or more secondary hubs may send details of the inventory to a primary hub. The details of the inventory is stored in a cache of the primary hub.

In one or more embodiments, reservation may be a process of blocking an inventory for a customer after applying appropriate sourcing rule and fulfillment constraints. The reservation process may take out an inventory out from a pool of available inventories, to cater demand of a customer (consumer).

The reservation request 602 for an inventory may be sent to a sourcing engine 612. Availability of the inventory may be checked in the sourcing step up 606 by the sourcing engine 612. The availability may be checked by sending the sourcing request 602 to the sourcing setup 606. In one or more embodiments, the sourcing setup 606 may be part of a cache associated with the primary hub 604. The sourcing engine 612 may check the availability of the inventory in one or more fulfillment nodes, but not limited to a distribution center and a drop-ship-vendor. In one or more embodiments, the availability of the inventory may be checked based on one or more of, but not limited to a priority, a proximity, a fulfillment cost, a number of shipments, and an expected delivery date.

In one or more embodiment, the sourcing setup 606 may comprise a sourcing template-1 614, a sourcing template—616, a distribution group 1-N 618, communicatively coupled with the sourcing template-1 614, and a distribution group 1-N 620, communicatively coupled with the sourcing template 616. A distribution center (DC) node 1 622 and a distribution center (DC) node N 624 may be communicatively coupled with the distribution group 1-N 618. A store hub node-1 626 and a store hub node-2 628 may be communicatively coupled with the distribution group 1-N 620.

A response may be sent to from the sourcing setup 606. Based on the response, the condition 630 may be checked. If a source node is at least one of a Distribution Center (DC) and a Drop-Ship-Vendor (DSV), the response may be sent to a node level reservation 632. Further, the response may be sent to the reservation request 602.

If the condition 630, is satisfied, a response may be sent to a node level reservation 632. The node level reservation may send the response to the reservation request 602.

In one or more embodiments, if the condition 630 is not satisfied, the request may be sent to hub level reservation 634. A condition, reservation against hub 1 636 may be checked. If the condition 636 is satisfied, the reservation request 602 and a hub level reservation information may be sent to the store promising hub-1 608, asynchronously. If the condition 636 is not satisfied, the reservation request 602 and the hub level reservation information may be sent to the store promising hub-2 610, asynchronously.

In one or more embodiments, if the inventory is not available in the primary hub 604, the sourcing engine 612 may check the availability of the inventory in a cache associated with the primary hub 604. The cache may contain information of inventories from one or more secondary hubs. The sourcing engine may create a hub level reservation by identifying a secondary hub from one or more secondary hubs. The primary hub 604 may send the reservation request 602 and the hub level reservation information to the identified secondary hub, asynchronously. The identification of the secondary hub may be based on one of, but not limited to a priority and a proximity from a customer's location.

In one or more embodiments, a hub level reservation may be blocking an inventory from a hub inventory cache. The hub level reservation may be performed for a demand from a customer by based on one of, but not limited to a location proximity and a priority logic.

In one or more embodiments, a node level reservation may be blocking an inventory from a primary hub or a secondary hub based on an inventory data for a customer demand. The node level reservation may be performed by applying at least one of sourcing rules and fulfillment constraints to ensure an appropriate node selection.

In one or more embodiments, a store promising hub-1 608 may comprise a store hub-1 sourcing rule 638 and sourcing template-1 640 to template-N 642. A store node-01 648 to a store node-100 650 may be connected to a distribution group 644. The distribution group 644 may be connected to the sourcing template-1 640. Similarly, a store node-101 652 to store node-200 654 may be connected to a distribution group 646. The distribution group 646 is connected to the sourcing template-N 642. The sourcing template-1 640 to sourcing template-N 642 may be communicatively coupled with the store hub-1 sourcing rule 638. The store promising hub-1 608 may further comprise Real Time Availability Monitor (RTAM) 656.

Similarly, a store promising hub-2 610 may comprise a store hub-2 sourcing rule 658 and sourcing template-1 660 to template-N 662. A store node-201 668 to a store node-300 670 may be grouped under a distribution group 664. The distribution group 554 may be connected to the sourcing template-1 660. Similarly, a store node-301 672 to store node-400 674 may be connected with distribution group 666. The distribution group 666 is connected to the sourcing template-N 662. The sourcing template-1 660 to sourcing template-N 662 may be communicatively coupled with the store hub-2 sourcing rule 658. The store promising hub-2 610 may further comprise Real Time Availability Monitor (RTAM) 676.

When the condition 636 is satisfied, the store promising hub-1 608 may be identified. The store promising hub-1 608 may be considered as an identified hub. A service running in the identified hub may receive the reservation request 602 and the hub level reservation information.

If the inventory is available in the identified secondary hub, the inventory may be allocated in a fulfillment node. The fulfillment node may be at least one of one or more store nodes associated with the identified secondary hub. The inventory may be allocated based on one or more of, but not limited to a priority, a proximity, a fulfillment cost, a number of shipments, an expected delivery date and a capacity of the fulfillment node capacity. The identified secondary hub may convert the hub level reservation information into a fulfillment node level reservation.

In one or more embodiments, a Real Time Availability Monitor (RTAM) may be a process running on a secondary hub to publish a hub level availability (consolidated for all fulfillment nodes hosted in a secondary hub) to a primary hub cache. RTAM process may be responsible to update the primary hub cache.

The sourcing engine 612 of the primary hub 604 may verify the availability of the inventory in the fulfillment node of the identified secondary hub. If the inventory is not available in the identified secondary hub, the reservation request 602 may be sent to the store promising hub 2 610 by the primary hub 604 based on the condition 636.

In one or more embodiments, if the inventory reservation information is sent as a response to the reservation request 602, the reservation request 602 may said to be serviced.

In one or more embodiments, a primary hub may send a reservation request to at least one of one or more secondary hubs to reserve an inventory. If the inventory is not available in one of the one or more secondary hubs, the reservation request may be sent to another secondary hub of the one or more secondary hubs. Identification of a secondary hub from the one or more secondary hub may be based on one of, but not limited to a priority and a proximity of customer's location.

In one or more embodiments, a picture of availability of an inventory may be updated at the cache associated with a primary hub. The update may be obtained from one or more secondary hubs, periodically.

In one or more embodiments, a Real Time Availability Monitor (RTAM) 656 and 676 may be communicatively coupled with a store hub node-1 626 and store hub node-2 628 respectively. The RTAM may provide information of inventory availability to a primary hub 604. Each of a one or more secondary hubs may be associated with the RTAM to send inventory information to a cache associated with the primary hub 604.

FIG. 7 is a block diagram, illustrating events of primary hub and secondary hub during inventory stock identification (sourcing) and allocation, according to one or more embodiments.

In one or more embodiments, the inventory availability check from hub inventory summary many be performed, as in 706. A hub identification logic 708 may be applied and a request may be sent to an order creation 710. An order creation event for identification of a fulfillment node may be sent from the primary hub 702 to the secondary hub 704. The table 712 may comprise inventory (item) names, a secondary hub, and a hub level Available To Promise (ATP). In one or more embodiments, an ATP of an item may be a picture availability of an inventory for an enterprise to promise to a consumer(s).

The fulfillment node may be identified from a distribution group, as in 714. If the inventory is found in the fulfillment node, the inventory may be allocated as in 716. As, the inventory count reduces due to an allocation and/or a reservation, an availability picture may be updated, as in 718. An inventory allocation notification may be sent to the primary hub 702. A request to update a cache associated with the primary hub 702, may also be sent by the secondary hub 704. The table 712 may be updated as per the update request and the notification.

In one or more embodiment, a table 720 may comprise a store and quantity information of an inventory available in the secondary hub 704. The table 720 may be updated based on availability of the inventory. Frequently updating the cache of the primary hub in light of information from the secondary hub may provide correct information of the availability of the inventory at any point of time.

In one or more embodiments, inventory grid may be an interceptor layer between an order capture channel and a multi-hub set up. The multi-hub setup may comprise a primary hub and a secondary hub. The inventory grid may provide inventory availability picture to the order capture channel. The inventory grid may minimize load on the order capture channel and the multi-hub setup.

In one or more embodiments, a multi-hub setup may be divided into two type of hubs: a primary hub and a secondary hub. The primary hub may act as a single view of order repository for an omni-channel commerce sale. The primary hub may hold an inventory promising information for a critical fulfillment points, such as distribution centers and critical stores. The critical fulfillment points may be responsible to fulfil eighty percent or greater of sales.

In one or more embodiments, a multi-hub setup may have multiple secondary hubs. The multiple secondary hubs may hold an inventory promising information for a cluster of store fulfillment nodes. The cluster of store fulfillment nodes may be responsible to source twenty percent or lesser of sales orders for save the sale scenario. The cluster of stores and one or more fulfillment nodes may be hosted in multiple secondary promising hubs.

The cluster of stores and one or more fulfillment nodes may be, but not limited to a vendor managed inventory, a manufacturer, a whole seller. A decision to identify number and nature of the fulfillment nodes (points) may be based on one or more models and customizable rules of an enterprise. A count/number of secondary hubs on-boarded in the multi-hub setup may be decided based on one or more of, but not limited to type of fulfillment, a total number of fulfillment nodes and an average assortment size in a store fulfillment node.

In one or more embodiments, an inventory supply information for items hosted in one or more distribution centers may be fed in a primary hub. Supply of items hosted in one or more secondary hubs may be fed to the one or more secondary hubs. Omni-Channel multi-hub order and inventory management system may allow the supply load distributed horizontally across various hubs.

The primary hub may comprise a local availability cache for each of the one or more secondary hubs, to provide seamless global visibility. A program running in each of one or more secondary hub may be responsible to keep the local availability cache at the hub level in primary hub up-to-date.

In one or more embodiments, a request for a sales order may be received at a primary hub. The primary hub may act as controller. The primary hub may first check availability of an inventory in the primary hub. If inventory is not available in the primary hub, the primary hub may identify a best possible secondary hub to fulfill the request. Identification of most relevant secondary hub may be performed based on a pre-defined priority or a proximity to a customer's delivery location. The request may be sent to the identified secondary hub through, but not limited to Java Message Service (JMS) queue.

A consumer process in the identified secondary hub may receive the request from the primary hub to identify an optimal fulfillment node(s) based on parameters of the request. In case of non-fulfillment of request in the identified secondary hub, a response may be sent to the primary hub. Based on the response, the primary hub may identify next optimal secondary hub and a fulfillment node. The primary hub may search the optimal fulfillment node until a fulfillment node is found, capable of fulfilling the request. In case of non-availability of the inventory, the request may be backordered.

In one or more embodiments, each hub (primary and secondary) hosts one or more sourcing rules configured to identify a fulfillment node for incoming sales order request. The identification of the fulfillment node may be based on one or more of, but not limited to a priority, a proximity, a fulfillment cost, a number of shipments, an expected delivery date, and a fulfillment node capacity.

In one or more embodiments, omni-channel multi-hub order and inventory management system may have a configuration to control number of hops for an allocation request. For example, the Omni-channel multi-hub order and inventory management system may look for availability of an inventory stock in four (4) hubs before backordering an order.

In one or more embodiments, communications between primary hub and one or more secondary may be made asynchronous. The asynchronous communication may be achieved through, but not limited to Java Message Services (JMS) messages. The primary hub and the one or more secondary hubs may be independent of each other in terms of technology dependency.

In one or more embodiments, a primary hub may be associated with one or more of, but not limited to application server instance, batch server instance and database server. A secondary hub may be associated with one or more of, but not limited to application server instance, batch server instance and database server. Decoupling of the primary hub and one or more secondary hubs may minimize interference between the primary hub and the one or more secondary hubs.

In one or more embodiments, inventory supply information for one or more items received from one or more nodes may be distributed to one or more hubs based on one or more configurations. The one or more configurations may be associated with the one or more nodes. The one or more nodes may be, but not limited to a distribution center, warehouse, manufacturer, and partner. The omni-channel multi-hub order and inventory management system may allow a supply load to distribute horizontally across multiple hubs to eliminate interference of the supply load.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A computer implemented method of omni-channel multi-hub order and inventory management system comprising:
receiving, through an order processor connected to a computer network, at an order capture channel of the inventory management system, a request for at least one inventory stock from a computing system;
checking, through a processor, availability of the at least one inventory stock in a computer database associated with a primary hub of the inventory management system;
when the at least one inventory stock is available, fulfilling through a processor, the received request at the primary hub of the inventory management system; and
when the at least one inventory stock is not available:
checking, through a processor, at a stock cache associated with at least one of a plurality of secondary hubs, for the inventory stock availability, wherein the stock cache associated with each of the plurality of secondary hubs consists of a stock summary of one or more fulfillment nodes; and
sending, through a processor, the received request to at least one of the plurality of secondary hubs asynchronously to fulfill an inventory stock from at least one of one or more fulfillment nodes.

2. The method of claim 1, further comprising, backordering the request at the primary hub when the inventory stock is not available at the stock cache of each of the plurality of secondary hubs.

3. The method of claim 1,
wherein the at least one of plurality of secondary hubs is chosen based on at least one of a proximity to a delivery location and a priority,
wherein each of the plurality of secondary hubs is associated with one or more fulfillment nodes, and
wherein each of the plurality of secondary hubs is communicatively coupled with the primary hub asynchronously.

4. The method of claim 1, wherein the stock summary is a collective information of the inventory stock at each of the one or more fulfillment nodes associated with each of the plurality of secondary hubs.

5. The method of claim 1, wherein the request is at least one of:
identification of the inventory stock availability in the plurality of secondary hubs, and
allocation of the inventory stock from one or more fulfillment nodes.

6. The method of claim 1, wherein each of the one or more fulfillment nodes is at least one of a distribution center, a store, a drop ship vendor, a supplier and a manufacturer.

7. A system for omni-channel multi-hub order and inventory management comprising:
a computer network;
one or more processors; and
one or more memory units operatively coupled to at least one of the one or more processors and having instructions stored thereon that, when executed by at least one of the one or more processors, cause at least one of the one or more processors to:
receive, at an order capture channel of the inventory management system, a request for at least one inventory stock from a computing system;
check, availability of the at least one inventory stock in a computer database associated with a primary hub of the inventory management system;
when the at least one inventory stock is available, fulfill the received request at the primary hub of the inventory management system; and
when the at least one inventory stock is not available:
check, at a stock cache associated with at least one of a plurality of secondary hubs, for the inventory stock availability, wherein the stock cache associated with each of the plurality of secondary hubs consists of a stock summary of one or more fulfillment nodes; and
send, the received request to at least one of the plurality of secondary hubs asynchronously to fulfill an inventory stock from at least one of one or more fulfillment nodes.

8. The system of claim 7, further comprising, backordering the request at the primary hub when the inventory stock is not available at the stock cache of each of the plurality of secondary hubs.

9. The system of claim 7,
wherein the at least one of plurality of secondary hubs is chosen based on at least one of a proximity to a delivery location and a priority,
wherein each of the plurality of secondary hubs is associated with one or more fulfillment nodes, and
wherein each of the plurality of secondary hubs is communicatively coupled with the primary hub asynchronously.

10. The system of claim 7, wherein the stock summary is a collective information of the inventory stock at each of the one or more fulfillment nodes associated with each of the plurality of secondary hubs.

11. The system of claim 7, wherein the request is at least one of:
identification of the inventory stock availability in the plurality of secondary hubs, and
allocation of the inventory stock from one or more fulfillment nodes.

12. The system of claim 7, wherein each of the one or more fulfillment nodes is at least one of a distribution center, a store, a drop ship vendor, a supplier and a manufacturer.

13. A non-transitory computer readable medium having stored thereon instructions omni-channel multi-hub order and inventory management system, comprising machine executable code which when executed by at least one processor, causes the at least one processor to perform steps comprising:
receiving, at an order capture channel of the inventory management system, a request for at least one inventory stock from a computing system;
checking, availability of the at least one inventory stock in a computer database associated with a primary hub of the inventory management system;
when the at least one inventory stock is available, fulfilling the received request at the primary hub of the inventory management system; and
when the at least one inventory stock is not available:
checking, at a stock cache associated with at least one of a plurality of secondary hubs, for the inventory stock availability, wherein the stock cache associated with each of the plurality of secondary hubs consists of a stock summary of one or more fulfillment nodes; and
sending, the received request to at least one of the plurality of secondary hubs asynchronously to fulfill an inventory stock from at least one of one or more fulfillment nodes.

14. The non-transitory computer readable medium of claim 13, further comprising, backordering the request at the primary hub when the inventory stock is not available at the stock cache of each of the plurality of secondary hubs.

15. The non-transitory computer readable medium of claim 13,
wherein the at least one of plurality of secondary hubs is chosen based on at least one of a proximity to a delivery location and a priority,
wherein each of the plurality of secondary hubs is associated with one or more fulfillment nodes, and
wherein each of the plurality of secondary hubs is communicatively coupled with the primary hub asynchronously.

16. The non-transitory computer readable medium of claim 13, wherein the stock summary is a collective information of the inventory stock at each of the one or more fulfillment nodes associated with each of the plurality of secondary hubs.

17. The non-transitory computer readable medium of claim 13, wherein the request is at least one of:
identification of the inventory stock availability in the plurality of secondary hubs, and
allocation of the inventory stock from one or more fulfillment nodes.

18. The non-transitory computer readable medium of claim 13, wherein each of the one or more fulfillment nodes is at least one of a distribution center, a store, a drop ship vendor, a supplier and a manufacturer.
